(19) United States
(12) Patent Application Publication
(10) Pub. No.: US 2016/0273360 A1
(43) Pub. Date: Sep. 22, 2016

(54) COOLING SYSTEM FOR A GAS TURBINE

(71) Applicant: Sulzer Turbo Services Venlo B.V., Lomm (NL)

(72) Inventors: Luc GOOREN, Zele (BE); Eric VAN DEN HOVEN, Boxmeer (NL)

(21) Appl. No.: 15/074,111

(22) Filed: Mar. 18, 2016

(30) Foreign Application Priority Data
Mar. 20, 2015 (EP) 15160092.1

(51) Int. Cl. F01D 5/08; F01D 5/26; F01D 5/22

(52) U.S. Cl. CPC F01D 5/081; F01D 5/225; F01D 5/26; F05D 2260/941; F05D 2260/221; F05D 2220/32; F05D 2240/81; F05D 2260/96

(57) ABSTRACT

The invention relates to a cooling system for a gas turbine.

The cooling system according the invention comprises an annular array of turbine blades which comprises an undercut (17) formed in a blade platform (11). A substantially cylindrical damper pin (22) is arranged between two turbine blades (10a and 10b). The damper pin (22) comprises a cut-out (23) which is constructed and arranged that at least a portion of a gas flow which generally flows from a blade root portion to a blade profile portion of the turbine blades is directed to the named undercut (17). Since the named gas flow has a lower temperature than the blade platform and especially than the undercut, a cooling of the undercut is performed by the gas flow.

### CROSS-REFERENCE TO RELATED APPLICATIONS

This application claims priority to EP Application No. 15160092.1, filed Mar. 20, 2015, the contents of which is hereby incorporated herein by reference.

### BACKGROUND

1. Field of the Invention

The invention relates to a cooling system for a gas turbine.

2. Background of the Invention

A cooling system for a gas turbine is disclosed in the U.S. Pat. No. 7,163,376 B2. The cooling system comprises adjacent turbine blade platforms in the form of bucket platforms having opposed slash faces and a generally cylindrical-shaped pin having a plurality of channels formed about peripheral portions of the pin at spaced axial locations there along for communicating a cooling medium through the channels and cooling at least one of the slash faces of the adjacent turbine blade platforms. The channels extend along opposite sides of said pin.

### SUMMARY

In view of this, it is in particular the object of the invention to propose a cooling system for a gas turbine, which enables turbine blades with very high thermal and mechanical load capacities. This object is satisfied in accordance with the invention by a cooling system for a gas turbine described herein.

The cooling system for a gas turbine according the invention comprises an annular array of turbine blades. Each turbine blade has a blade platform having a blade trailing edge side, a blade convex side, a blade concave side and a blade leading edge side. The turbine blades further comprise a blade profile portion connected to the blade platform and a blade root portion connected to the blade platform arranged on the other side of the blade platform in relation to the blade profile portion. Additionally the turbine blades comprise an undercut formed in the blade platform. The undercut is formed as a groove, which in particular runs from the blade concave side to the blade trailing edge side of the blade platform. It is also possible that the undercut is formed as a groove, which runs from the blade concave side to the blade convex side of the blade platform. The undercut results in a reduced mechanical and thermal stress condition in a root trailing edge of the blade profile portion and a higher stressed condition in the undercut. This is possible because the groove is located in a region of cooler metal temperature having greater material fatigue strength.

The turbine blades are arranged so that the blade convex side of the blade platform of a first turbine blade faces towards a blade concave side of the blade platform of a second turbine blade. Each blade convex side and each blade concave side include an elongated in particular at least in part arcuate groove and an in particular substantially cylindrical damper pin disposed along adjacent pairs of such grooves. The damper pin is used to dampen vibrations especially during startup and shutdown of the gas turbine and at operational speed of the gas turbine. The damper pin comprises a cut-out which is constructed and arranged so that at least a portion of a gas flow which generally flows from the blade root portion to the blade profile portion is directed to the undercut. Since the gas flow has a lower temperature than the blade platform and especially the undercut, a cooling of the undercut is performed by the gas flow. The gas flow is caused by a higher pressure of the gas in the area of the blade root portion in comparison to the pressure of the gas in the blade profile portion. So the cooling system, according the invention, enables particularly low temperatures of the undercut, so the mentioned technical effect of the undercut is very high which results in turbine blades with very high thermal and mechanical load capacities. Since the manufacturing of the damper pin including the cut-out is very easy and cheap, an easy and cost effective realization of the cooling system is possible.

In an aspect of the invention, the damper pin comprises only one cut-out. This configuration results in a very strong gas flow through this only one cut-out and thus a very effective cooling of the undercut and a very low temperature of the undercut.

In an advantageous embodiment of the invention, the cut-out runs over the whole circumference of the damper pin.

In an advantageous embodiment of the invention, the cut-out is in axial direction spirally executed. This results in an additional gas flow in the axial direction of the damper pin. This additional gas flow cools the environment of the damper pin and so indirectly the undercut. So a direct and an indirect cooling of the undercut is performed. This results in an especially effective cooling of the undercut.

The cut-out of the damper pin has especially a width in axial dimension between 5 and 12 mm and a depth in radial direction between 1 and 4 mm.

Further advantages, features and details of the invention result with reference to the following description of embodiments and with reference to the drawings in which elements which are the same or have the same function are provided with identical reference numerals.

### BRIEF DESCRIPTION OF THE DRAWINGS

The invention will be explained in more detail hereinafter with reference to the drawings.

FIG. 1 is a side view of a gas turbine blade from a concave side of the turbine blade,

FIG. 2 is a top view of the turbine blade of FIG. 1,

FIG. 3 is a sectional view of two adjacent turbine blades with a damper pin arranged between the turbine blades,

FIG. 4 is a damper pin,

FIG. 5 is a first alternative embodiment of the damper pin, and

FIG. 6 is a second alternative embodiment of the damper pin.

### DETAILED DESCRIPTION OF THE EMBODIMENTS

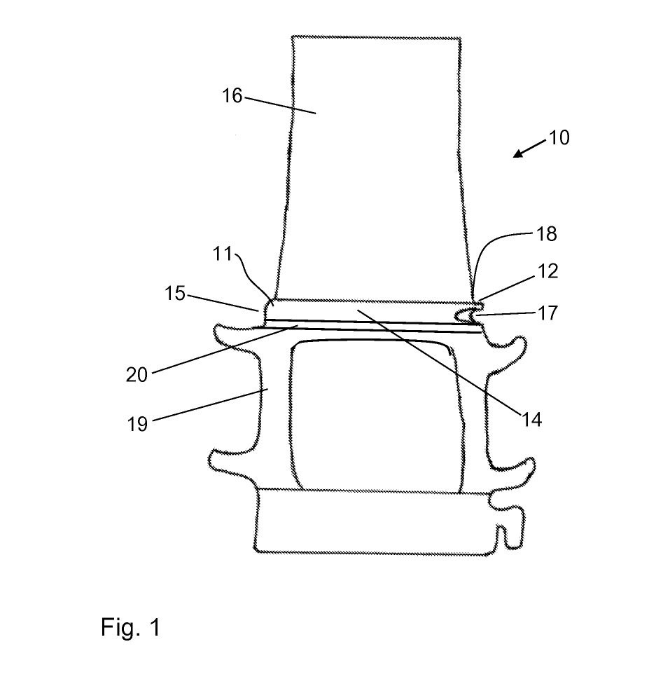

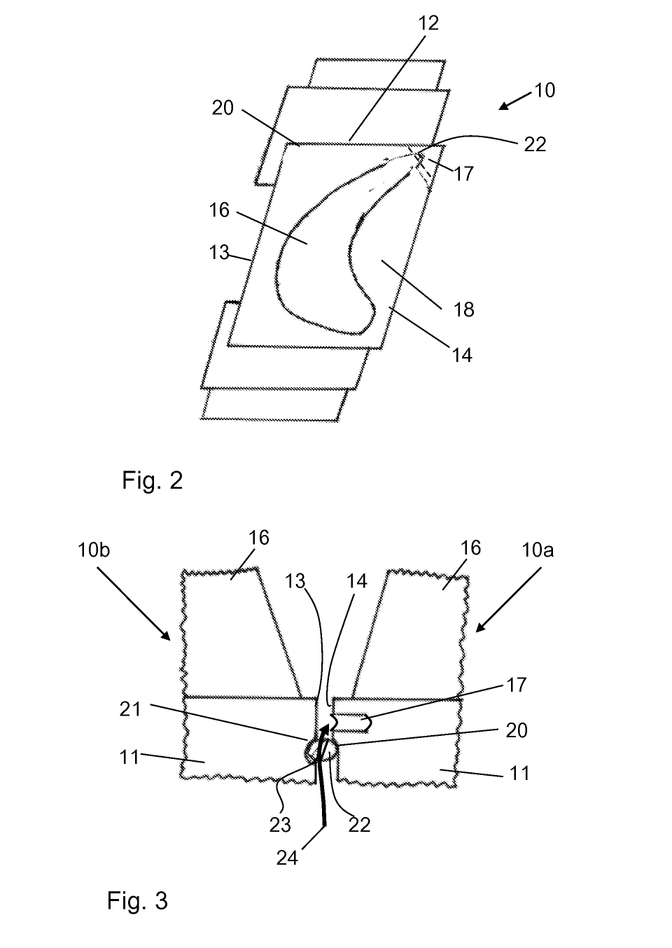

In accordance with FIG. 1, a gas turbine blade 10 comprises a blade platform 11 having a blade trailing edge side 12, a blade convex side 13 (not visible in FIG. 1, see FIG. 2), a blade concave side 14 and a blade leading edge side 15. A blade profile portion 16 is connected to the blade platform 11. A blade root portion 19 is connected to the blade platform 11 arranged on the other side of the blade platform 11 in relation to the blade profile portion 16. The sides of the blade platform 11 are labeled according to their position relative to the blade profile portion 16. An undercut 17 is disposed in the blade platform 11, such that the undercut 17 runs from the blade concave side 14 to the blade trailing edge side 12. The undercut 17 is formed as a groove which runs in a plane below a surface 18 (see also FIG. 2) of the blade platform 11.

A groove 20 for receiving a damper pin (see FIG. 3) runs on the blade concave side 14 of the blade platform 11 in a plane parallel to the surface 18 of the blade platform 11. The undercut's 17 plane is arranged between the surface 18 of the blade platform 11 and the groove's 20 plane. The groove 20 has an in part arcuate cross section (see FIG. 3). There is a corresponding groove 21 located at the blade convex side 13 of the blade platform 11 which is not visible in FIG. 1 but in FIG. 3.

In accordance with FIG. 2 the undercut 17 (the edged is indicated as a dotted line) runs in a straight line from the blade concave side 14 to the blade trailing edge side 12.

The undercut 17 comprises an inner part with a round cross-section and an outer part with a rectangular cross section (not shown). It's also possible that the inner part of the cross section of the second portion of the groove has an elliptical cross section.

A couple of turbine blades 10 according FIGS. 1 and 2 are arranged so that they build an annular array. FIG. 3 shows the arrangement of two adjacent turbine blades 10a, 10b. The two turbine blades 10a, 10b are arranged so that the blade concave side 14 of the first turbine blade 10a faces towards the blade convex side 13 of the second turbine blade 10b. The blade concave side 14 of the first turbine blade 10a comprises the groove 20 and the blade convex side 13 of the second turbine blade 10b the corresponding groove 21 which have both an at least in part arcuate cross section. A substantially cylindrical damper pin 22 is disposed in this pair of grooves 20, 21. The damper pin 22 comprises a cut-out 23 which is constructed and arranged that at least a portion of a gas flow 24 which generally flows from the blade root portion 19 to the blade profile portion 16 is directed to the undercut 17 of the turbine blade 10a.

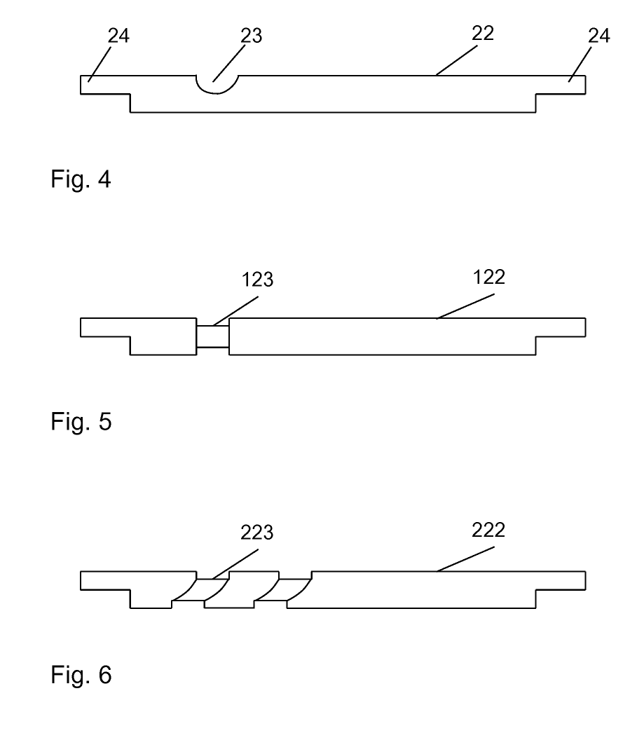

In FIG. 4 the damper pin 22 is shown in more detail. The damper pin has a substantially cylindrical form with recess surfaces 24 at both ends. The cut-out 23 has i.e. a cross section in axial direction in a form of a circular segment. The cut-out 23 has especially a width in axial dimension between 5 and 12 mm and a maximal depth in radial direction between 1 and 4 mm.

In FIG. 5 an alternative damper pin 122 is shown. The substantial form of the damper pin 122 is similar to the substantial form of the damper pin 22. There are only differences in the design of the cut-out 123. The cut-out 123 runs over the whole circumference of the damper pin 122. It is formed by a recess with a constant depth in radial direction between 5 and 12 mm and a constant width in axial direction between 1 and 4 mm.

In FIG. 6 a second alternative damper pin 222 is shown. The substantial form of the damper pin 222 is similar to the substantial form of the damper pin 122. There are only differences in the design of the cut-out 223. The cut-out 223 also runs over the whole circumference of the damper pin 222 but the cut-out 223 of the damper pin 222 is additionally spirally executed in axial direction.

1. A cooling system for a gas turbine, comprising:
an annular array of turbine blades, the annular array of turbine blades including at least a first turbine blade and a second turbine blade, each turbine blade having
a blade platform having
a blade trailing edge side, a blade convex side,
a blade concave side and a blade leading edge side,
a blade profile portion connected to the blade platform,
a blade root portion connected to the blade platform, and being arranged on the other side of the blade platform in relation to the blade profile portion, and
an undercut formed in the blade platform,
the turbine blades being arranged so that the blade convex side of the blade platform of the first turbine blade faces towards the blade concave side of the blade platform of the second turbine blade,
each blade convex side and each blade concave side including an elongated groove, and
a damper pin disposed along adjacent pairs of the elongated grooves, wherein that the damper pin comprises comprising a cut-out which is constructed and arranged such that at least a portion of a gas flow which generally flows from the blade root portion to the blade profile portion is directed to the undercut.

2. A cooling system in accordance with claim 1, wherein the undercut runs form extends from the blade concave side to the blade trailing edge side of the blade platform.

3. A cooling system in accordance with claim 1, wherein the damper pin comprises only one cut-out.

4. A cooling system in accordance with claim 1 wherein the cut-out runs extends over an entire circumference of the damper pin.

5. A cooling system in accordance with claim 1, wherein the cut-out extends in an axial direction and has a spiral configuration.

6. A cooling system in accordance with claim 1, wherein the cut-out has an axial width in axial dimension between 5 and 12 mm.

7. A cooling system in accordance with claim 1, wherein the cut-out has a depth in a radial direction between 1 and 4 mm.

8. A cooling system in accordance with claim 2, wherein the damper pin comprises only one cut-out.

9. A cooling system in accordance with claim 2 wherein the cut-out extends over an entire circumference of the damper pin.

10. A cooling system in accordance with claim 3 wherein the cut-out extends over an entire circumference of the damper pin.

11. A cooling system in accordance with claim 2, wherein the cut-out extends in an axial direction and has a spiral configuration.

12. A cooling system in accordance with claim 3, wherein the cut-out extends in an axial direction and has a spiral configuration.

13. A cooling system in accordance with claim 4, wherein the cut-out extends in an axial direction and has a spiral configuration.

15. A cooling system in accordance with claim 2 wherein the cut-out has an axial width dimension between 5 and 12 mm.

16. A cooling system in accordance with claim 3, wherein the cut-out has an axial width dimension between 5 and 12 mm.

17. A cooling system in accordance with claim 4, wherein the cut-out has an axial width dimension between 5 and 12 mm.

18. A cooling system in accordance with claim 5, wherein the cut-out has an axial width dimension between 5 and 12 mm.

19. A cooling system in accordance with claim 2, wherein the cut-out has a depth in a radial direction between 1 and 4 mm.

20. A cooling system in accordance with claim 3, wherein the cut-out has a depth in a radial direction between 1 and 4 mm.
